(19) United States
(12) Patent Application Publication
(10) Pub. No.: US 2008/0156912 A1
(43) Pub. Date: Jul. 3, 2008

(54) Touch-stop safety device for shredder opening

(75) Inventor: Simon Huang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/878,487

(22) Filed: Jul. 25, 2007

(30) Foreign Application Priority Data
Dec. 28, 2006 (CN) 200620139399.2

(51) Int. Cl. B02C 23/04

(52) U.S. Cl. 241/37.5

(57) ABSTRACT

The invention discloses a touch-stop safety device for the shredder opening. A protection board is pivotally installed on both sides of the opening of a shredder housing. The protection board is adjacent to the switch. When the protection board is under a pressure caused by an inserted finger, it rotates clockwise and touches the switch to power off the shredder. The shredding blades thus stop rotating so that the user is not hurt.

### BACKGROUND OF THE INVENTION

1. Field of Invention

The invention relates to a shredder and, in particular, to a shredder with a movable protection board installed at its opening. When the user's finger touches the protection board and rotates it clockwise, the switch is turned off, preventing the user's finger from being hurt.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

The US Consumer Product Safety Commission (CPSC) issued document No. 5127 in response to paper shredder safety alert. The document reminded families with shredders to be cautious about the safety in operating the shredders. It pointed out that 31 cases of finger injuries from operating shredders have been the received reports between January 2000 and December 2003, and most of the people who got hurt were children aged from 14 months to 2 years, particularly the toddlers. This is because children at these ages like to mimic adults and play shredder without the adult's supervision. It is not guaranteed that no accident will happen even under the adult's supervision. This is because the pulling force exert by the shredder on the paper is very large. If the fingers holding the paper do not let go, the pulling force may also pull the fingers into the shredder opening and cause injuries.

Therefore, the CPSC cautioned consumers about the following things:
1. Do not let children to operate shredders by themselves. Even under supervision, the adult should know that there is a risk that the pulling force of the shredder may be strong enough to pull children's fingers into the shredder opening.
2. Keep shredders away from children.
3. Unplug the shredder when not in use.
4. Do not put hands or fingers on the shredder.
5. Do not operate shredders when wearing clothes with loose ends or strips to avoid being pulled into the shredder opening.
6. Keep an appropriate distance between the tie or zipper and the shredder opening.

The opening width of an ordinary shredder may be wide enough for a child to stick in fingers and get hurt by the blades. Therefore, it is imperative to provide a safety protection device at the opening to prevent injuries.

### SUMMARY OF THE INVENTION

In view of the foregoing, an objective of the invention is to provide a touch-stop safety device for a shredder opening. A movable protection board is installed at the shredder opening. When the user's fingers touch the protection and rotate it clockwise, it touches the switch to turn off the shredder, preventing possible injures.

To achieve the above-mentioned objective, the disclosed touch-stop safety device for the shredder opening has a movable protection board pivotally installed on both sides of the opening. The protection board is adjacent to the switch. When the protection board is under a pressure caused by an inserted finger, it rotates clockwise and touches the switch to power off the shredder. The shredding blades thus stop rotating so that the user is not hurt.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the invention;

FIG. 2 is a planar view of the invention when the protection board is not under any pressure; and

FIG. 3 is a planar view of the invention after the protection board is under a pressure.

### DETAILED DESCRIPTION OF THE INVENTION

The present invention will be apparent from the following detailed description, which proceeds with reference to the accompanying drawings, wherein the same references relate to the same elements.

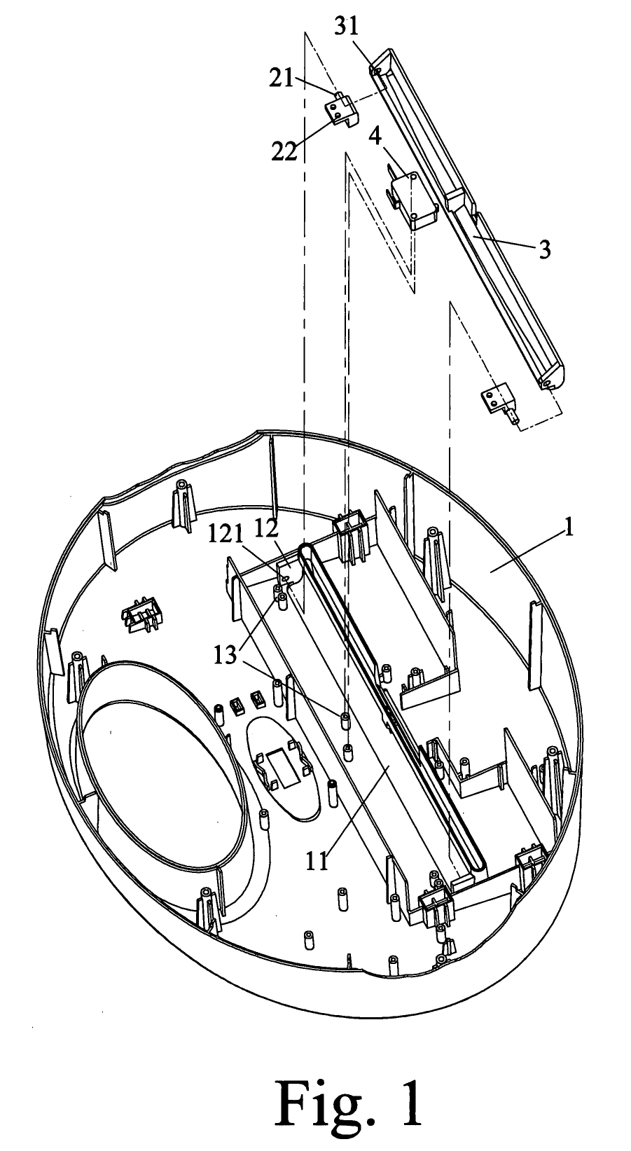

As shown in FIG. 1, both sides of the opening 11 of the shredder housing 1 are formed with plates 12. The plates 12 are formed with positioning holes 121 for a positioning axis 2. The pivotal rod 21 of the positioning axis 2 go through a through hole 31 of a protection board 3. A body 22 is fixed on a positioning base 13 inside the shredder housing 1. Therefore, the protection board 3 can rotate freely about the pivotal rod 21. A switch 4 is fixed on the positioning base 13 inside the shredder housing 1 behind the protection board 3.

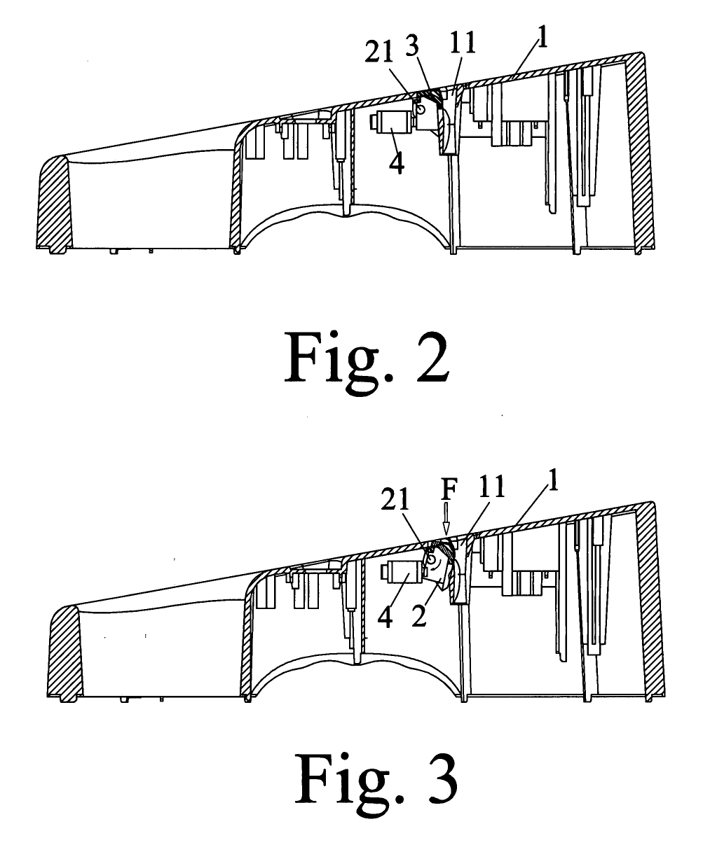

With reference to FIGS. 2 and 3, when the protection board 3 is not under any pressure, the switch 4 is kept on. When the protection board 3 is under the pressure of an inserted finger (as indicated by the arrow F in FIG. 3), it rotates clockwise (as indicated by the little arrow in FIG. 3) and touches the switch 4, turning off the power of the shredder. Therefore, even if the finger is inserted into the opening, the shredding blades (not shown) inside the shredder do not hurt the user because they are not operating. This greatly enhances the safety of the shredder.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch-stop safety device for a shredder opening, comprising:
a housing with an opening;
a switch installed on one side of the opening; and
a protection board pivotally installed at the opening of the housing;
wherein the protection board rotates from its normal position under no pressure to a pressured position to activate the switch to turn off the power of the shredder.

2. The touch-stop safety device for a shredder opening of claim 1, wherein both sides of the opening are formed with plates each of which is formed with a positioning hole for pivotally installing a positioning axis.

3. The touch-stop safety device for a shredder opening, wherein the pivotal rod of the positioning axis goes through a through hole of the protection board, with it body being fixed on the positioning base inside the housing, so that the protection board is allowed to pivotally rotate.
